(19) United States
(12) Patent Application Publication
(10) Pub. No.: US 2023/0396674 A1
(43) Pub. Date: Dec. 7, 2023

(54) MOBILE SECURE NETWORK SYSTEM AND DEVICE

(71) Applicant: DENG IP HOLDER, LLC, Rocky Hill, CT (US)

(72) Inventor: Alan Tan, Rocky Hill, CT (US)

(73) Assignee: DENG IP HOLDER, LLC, Rocky Hill, CT (US)

(21) Appl. No.: 18/236,343

(22) Filed: Aug. 21, 2023

Related U.S. Application Data
(63) Continuation-in-part of application No. 17/385,845, filed on Jul. 26, 2021, now Pat. No. 11,736,836.
Application No. 17/385,845 is a continuation-in-part of application No. 16/833,396, filed on Mar. 27, 2020, now Pat. No. 11,356,432.

(51) Int. Cl. H04L 67/1095; H04Q 1/02; H04L 9/40

(52) U.S. Cl. CPC H04L 67/1095; H04Q 1/025; H04L 63/107

(57) ABSTRACT

A mobile security system and device that provides a physically secured network device to extend a home network anywhere in the world is disclosed. The mobile security system and device has integrated logical and physical security and may be transported into an area with no suitable internet connection or very limited bandwidth and be self-sufficient and secured. The mobile security system and device includes a housing enclosing a computing apparatus, an access control mechanism to secure a door of the housing in a closed position, and a security control module to protect the data stored on the computing apparatus and provide authentication to access the enclosure. A back-up power supply supported by the housing and a wireless router to provide wireless network access to remote home network may also be provided.

### RELATED APPLICATIONS

This application claims priority to U.S. Non-Provisional application Ser. No. 17/385,845, filed Jul. 26, 2021, which claims priority to U.S. Non-Provisional application Ser. No. 16/833,396 that issued as U.S. Pat. No. 11,356,432, the entire disclosure of all of the foregoing being incorporated herein by reference.

### TECHNICAL FIELD

This disclosure relates to a mobile, secure network system and device, more specifically, to a physically and electronically protected mobile system for housing a computer network, which provides a secure mobile extension of the computer network from a remote home network, and which may be self-driven from one location to another.

### BACKGROUND

Data centers that house computer networks for the remote storage, processing, and/or distribution of large amounts of data are well known in the art. These data centers are configured according to the requirements of the user or for specific purposes, such as financial transaction processing, enterprise data storage, or global communications, to name but a few. The computer networks housed in the data centers store and transmit information essential to the user's operations. Security of data centers is a known issue to those of skill in the art and is accomplished by limiting and tracking physical access to the data centers. Because data centers house valuable information on the computer networks, most data centers contain lockable doors, cabinets and/or racks to limit access to the network components and power supplies supported therein.

Cabinet and/or rack security and monitoring in data centers hasn't changed much over the years. Traditionally racks and/or cabinets have a manual key to lock them. They may also have keycode access in addition or in lieu of a traditional key and may utilize card reader technology to provide electronic access via smart locks that validate a user's credentials with a central server, responding with a signal to unlock the cabinet, or unlocking remotely when instructed by an authorized user. An audit log of users who have accessed the data center may also be maintained for tracking purposes.

### BRIEF SUMMARY

While security measures for data centers are generally effective because they are locked, hard to move, and contained within large, secured rooms, mobile or portable server racks do not enjoy enhanced security as their mobile nature makes them vulnerable to break-ins. Mobile computer devices that can be utilized in remote locations are desirable for a variety of industries and reasons. Many industries send workers to remote areas where there is no internet connectivity, or to client locations where access to the clients' internet is undesirable for security or other reasons. A mobile secure system and device that provides security and accountability of the use of the computer network and equipment contained within the mobile security system, wherever it is located, is therefore desirable.

A physically and electronically protected mobile security system and device for housing computing apparatus, which provides a secure extension of a remote home network to a current location of the computing apparatus is disclosed herein. The mobile security system uses an identical, logistical and physical access control system as the parent facility. The mobile system includes a housing supporting the computing apparatus, may include a door to access the computing apparatus, and may also include a back-up power supply supported thereon, a wireless router also supported by the housing to provide wireless network access to the remote home network, an access control mechanism to secure the door in a closed position relative to the housing, and a security module to protect the data stored on the computing apparatus and provide authentication to access the housing.

In one exemplary embodiment, the security module may comprise a local cache of users who have authorization to unlock the enclosure. The local cache can also be configured to track users who have accessed the credential reader. The security module may be configured to synchronize the local cache with a cache located on the remote home network. The local cache may also be used to cache data determined by a data center to be unnecessary to sync with the remote home network.

In another embodiment, the access control mechanism is configured to deny access to the enclosure if the security module fails to synchronize the local cache with the cache located on the remote home network. The mobile secure network device may include a kill switch to physically disable access to the enclosure by deactivating the credential reader upon a set number of tries by an unauthorized user, who is not matched to a user in the local cache of authorized users. In another embodiment, when the kill switch is activated, it also clears the local cache and disables access to the remote home network. Upon activation of the kill switch, either by an attempted unauthorized user, or a forced physical breach, a fail secure device sends a signal to clear the local cache and disable remote access to the home network. The computing apparatus may also include a global positioning system supported by the housing so that the location of the secure network device can be tracked remotely, as desired, in case of a breach. The computing apparatus may also include a motion-activated camera supported by the housing that, when activated, records the environment around the housing, including those trying to access the housing. The recording may be sent by the motion-activated camera to the security control module in order to locally cache the recording, for example through use of an ethernet cable or wirelessly. The recordings are periodically synced with the home network and, upon a breach of security, the recordings that remain locally cached are automatically sent to the home server prior to deleting the local cache.

In a further exemplary embodiment, the mobile security system may be independently self-mobilize, i.e., self-driven, not requiring an external force to move its location. Sensors may provide data that can assist in directing the movement of the housing from one location to another. The mobile secure network system and device as described herein includes integrated logical and physical security and has the capability of being fully portable and self-movable.

The mobile secure network system and device is a physically secured network device that allows anyone to extend their network anywhere in the world where there is access to power. Caching and bandwidth optimization within the router makes it possible for the system to operate as a full local datacenter environment in a remote location, even with very slow internet, because bandwidth optimization can synchronize the local cache as usage permits, while authorization requests are sent directly to the home datacenter as higher priority traffic. The mobile security system may be rolled and/or driven into an area with no internet connection and be self-sufficient and secured.

### BRIEF DESCRIPTION OF THE DRAWINGS

Various aspects of at least one embodiment are discussed below with reference to the accompanying figures, which are not necessarily drawn to scale, emphasis instead being placed upon illustrating the principles disclosed herein. The figures are included to provide an illustration and a further understanding of the various aspects and embodiments and are incorporated in and constitute a part of this specification but are not intended as a definition of the limits of any particular embodiment. The figures, together with the remainder of the specification, serve only to explain principles and operations of the described and claimed aspects and embodiments, but are not to be construed as limiting embodiments. In the figures, each identical or nearly identical component that is illustrated in various figures is represented by a like numeral. For purposes of clarity, not every component may be labeled in every figure.

FIG. 1 is a perspective view of mobile secure network device in accordance with a first embodiment;

FIG. 2 is a schematic view of the mobile secure network system and device of FIG. 1;

FIG. 3 is a flowchart illustrating an embodiment of a security module and locking mechanism for securing the mobile secure network device according to embodiments disclosed herein;

FIG. 4 is a flowchart illustrating an embodiment of the security module for synchronizing the local cache with the remote network according to embodiments disclosed herein;

FIG. 5 is a schematic view of mobile secure network device in accordance with FIG. 1:

FIG. 6 is a flowchart illustrating an embodiment of a mobile secure network device in accordance with FIG. 1 including a motion-activated camera;

FIG. 7 is a perspective view of mobile secure network device having sensors and independent mobility;

FIGS. 8a, 8b, 8c, 8d and 8e are exemplary illustrations of various types of independent mobility mechanisms. FIG. 8a illustrates a thread type drive, FIG. 8b illustrates a wheel drive, FIG. 8c illustrates a tripod legged drive, FIG. 8d illustrates a bottom view of inline and staggered alignment of the drives; FIG. 8e illustrates a drive and steering motor; and

FIG. 9 illustrates an embodiment of a mobile secure network device in accordance with FIG. 7 including sensors and independent mobility.

### DETAILED DESCRIPTION OF THE ILLUSTRATIVE EMBODIMENTS

The examples of the system and device discussed herein are not limited in application to the details of construction and the arrangement of components set forth in the following description or illustrated in the accompanying drawings. It will be understood to one of skill in the art that the system and device is capable of implementation in other embodiments and of being practiced or carried out in various ways. Examples of specific embodiments are provided herein for illustrative purposes only and are not intended to be limiting. Also, the phraseology and terminology used herein is for the purpose of description and should not be regarded as limiting. Any references to examples, embodiments, components, elements or acts of the system and device herein referred to in the singular may also embrace embodiments including a plurality, and any references in plural to any embodiment, component, element or act herein may also embrace embodiments including only a singularity (or unitary structure). References in the singular or plural form are not intended to limit the presently disclosed system and device, its components, acts, or elements. As used herein, the singular forms “a”, “an” and “the” are intended to include the plural forms as well, unless the context clearly indicates otherwise. The use of “including,” “comprising,” “comprises,” “having,” “containing,” “involving,” and variations thereof in the specification is meant to encompass the items listed thereafter and equivalents thereof but do not preclude the presence or addition of one or more other features or items. References to “or” may be construed as inclusive so that any terms described using “or” may indicate any of a single, more than one, and all of the described terms.

As will be appreciated by one skilled in the art, aspects of the system and device disclosed herein may be embodied as a system, method or device. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. Program code embodied on a computer readable medium may be transmitted using any appropriate medium, including but not limited to wireless, wireline, optical fiber cable, RF, etc., or any suitable combination of the foregoing. Transmission of code and/or data to and/or from a mobile secure network device may be encrypted by any of a variety of methods known to one skilled in the art.

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions.

In referencing the flowchart illustrations and/or block diagrams, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

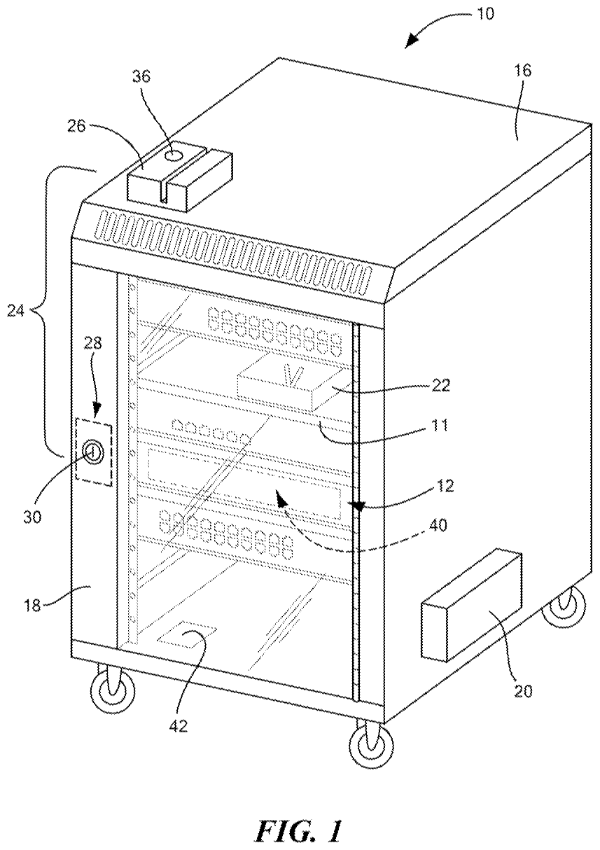

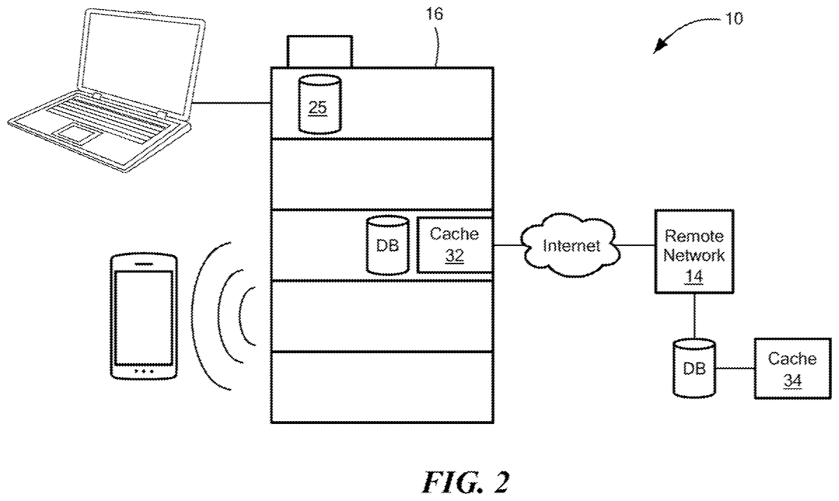

Referring initially to FIGS. 1 and 2, the present disclosure is directed to a physically and electronically protected mobile security system and device 10 for housing a computing apparatus 12, which provides a secure extension of a remote home network 14, to a current location of the computing apparatus. As used herein the term “computing apparatus” refers to the electronic equipment housed within the mobile security device for use with the home network, including but not limited to servers, patch panels, routers, and switches. The mobile security system 10 includes an enclosure, i.e. housing 16 enclosing the computing apparatus 12 that may include a door 18 to access the computing apparatus 12, an access control mechanism 24 to secure the door 18 in a closed position relative to the housing 16, and a security control module 25 to protect the data stored on the computing apparatus 12 and provide authentication to access the enclosure 16. Housing 16 may also include support members, for example racks 11 including rails to secure the computing apparatus within the housing 16 and which may be slidable, a back-up power supply 20 supported by the housing 16 and a wireless router 22 to provide wireless network access to the remote home network 14. The back-up power supply 20 can be optionally recharged by solar cells, thermal cells, fuel cells (such as hydrogen) as well as AC or DC power sources.

In the present embodiment, access control mechanism 24 is in communication with the remote home network 14 to validate requests to unlock the door 18. The access control mechanism 24 may include a credential reader 26 and a locking device 28. The credential reader 26 may be communicationally connected to the door 18, and the locking device 28 may be any of a variety of locking devices including a traditional lock 30, The security control module 25 communicates with the credential reader 26 and the access control mechanism 24 to allow access to the computing apparatus 12 by unlocking the lock 30 upon verification of credentials by the home network 14.

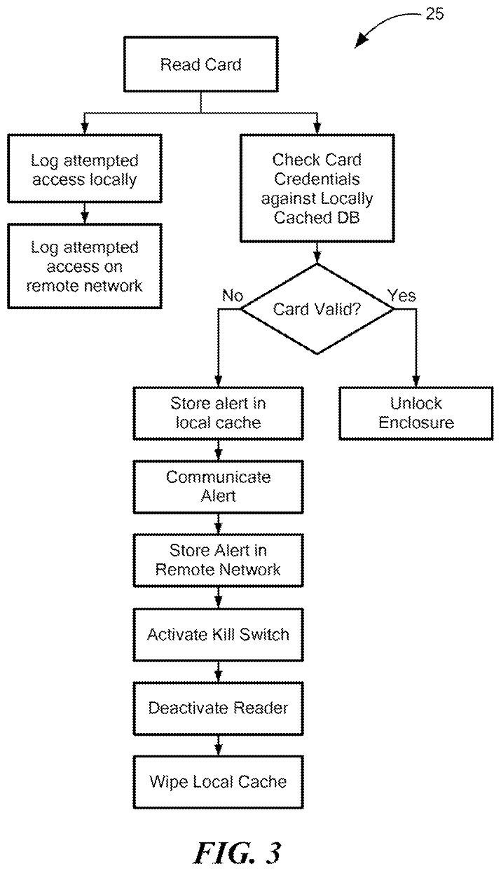

In one embodiment, as illustrated in FIG. 3, the security control module 25 includes the locally cached database 32 of users with authorization to unlock the housing 16. To gain access to the housing 16 the credentials read by credential reader 26 may be checked against the locally cached database of authorized users. If the user's identity matches those in the locally cached database 32, the card is validated and the door 18 is unlocked. If the user's identity does not match those in the locally cached database 32, the card is invalid and an alert is stored in the local cache and may also be communicated and stored in the remote home network 14. In this manner, unauthorized attempts to gain access to the mobile security system and device 10 can be stored in an audit log. The local cache 32 can also be configured to track users who have accessed the credential reader 26 and likewise store those who have accessed the mobile security system and device 10 in an audit log, either locally or remotely.

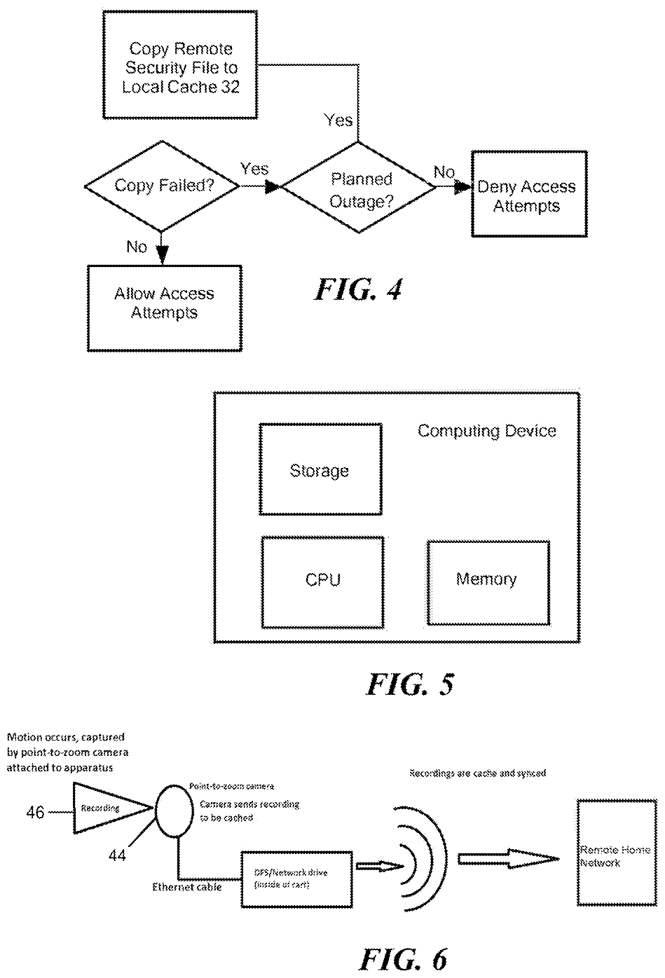

As illustrated in FIG. 4, the security control module 25 may also be configured to synchronize the local cache 32 with a cache 34 located on the remote home network 14. The local cache 32 may also be used to cache data determined to be unnecessary to sync with the remote home network 14. The access control mechanism 24 may also be configured to deny access to the housing 16 if the security module 26 fails to synchronize the local cache 32 with the cache 34 located on the remote home network 14.

If access is denied by the security control module 25 upon a predefined occurrence, for example from lack of authorization or for failure to synchronize the local cache 32, a shutdown protocol may be initiated. The mobile secure system 10 may include a kill switch 36 to physically disable access to the housing 16 by deactivating the credential reader 26 (for example upon a set number of tries by a user who is not matched to a user in the local cache 32 of users or if synchronization fails). In one embodiment, when the kill switch 36 is activated it also clears (i.e. wipes, deletes, destroys) the data stored on the local cache 32 and disables access to the remote home network 14. A fail secure device 38 may be provided in order to signal a forced breach of the mobile secure network device and activate the kill switch. The fail secure device 38 may be any known device that activates a signal upon a physical breach, including for example a glass shatter sensor, a lock sensor, and/or a power sensor.

In case of an emergency, where removal of the computing apparatus 12 from the housing 16 is desired, an emergency key that allows removal of the computing apparatus 12 may be provided. The emergency key in the present embodiment is a physical key, which may be stored remotely from the housing in a secure location, and that can be used to access a lock disposed on the back of the housing in case the electronic lock fails. Accessing the housing 16 from the back allows the user to access the inside of the housing to remove the side panel, and/or dismantle the computing apparatus 12 that is rack mounted from the inside out. When entering the housing with the credential reader 26 and locking device 28 from the front, access is provided but removal of the computing apparatus 12 is not readily feasible. In addition, a tamper indicator, for example tamper tape or a pressure sensor may be provided to indicate rear access to the housing, which can afterwards be reset electronically and/or physically. For example, if a pressure sensor is used, it would first need to be placed into its original position and then electronically reset. If tamper tape is utilized it would need to be physically replaced. Accordingly, when the emergency key is utilized it would be evident.

Alternatively, biometric data may be used to secure and access the mobile secure network system and/or various types of secondary authentication. This enhances the security of the network and a predetermined or dynamically determined number of invalid attempts can trigger a remote alert/alarm as well as may activate data erasure by any of a variety of methods.

The computing apparatus 12 may include a server 40 that communicates with the remote home network 14 over a secure network channel, for example a VPN channel or a local wireless network. The local wireless network may include a WiFi network, a cellular network, and/or a mesh network, or similar network. The computing apparatus may further include a global positioning system 42 supported by the housing 16 so that the location of the secure network device 10 can be tracked remotely as desired. The computing apparatus may also include a motion-activated camera 44 supported by the housing 16 that, when activated, records the environment around the housing 16, including those trying to access the housing 16. The recording 46 is sent by the motion-activated camera to the security control module 25 in order to locally cache the recording, for example through use of an ethernet cable or wirelessly. The recordings are periodically synced with the home network 14 and, upon a breach of security, the recordings that remain locally cached are automatically sent to the home network 14 prior to deleting the local cache.

The mobile security system and device 10 provides a physically secured network device that allows anyone to extend their network anywhere in the world with access to power. Caching and bandwidth optimization within the router makes it possible for the system to operate as a full local datacenter environment in a remote location, even with very slow internet, because bandwidth optimization can synchronize the local cache as usage permits, while authorization requests are sent directly to the home datacenter as higher priority traffic. The mobile security system may be rolled, driven, or otherwise moved or self-propelled into an area with no internet connection and be self-sufficient and secured. The mobile device has integrated logical and physical security and has the capability of being fully portable.

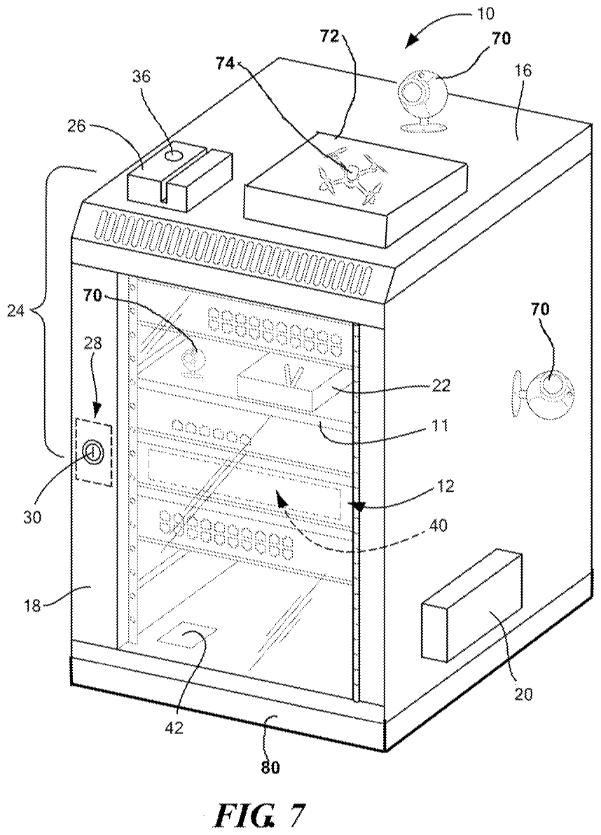

Referring now to FIG. 7, a perspective view of an exemplary embodiment of an independently, self-mobile secure network device 10 including sensors 70 and mobility mechanism 80 is shown. Sensors 70 are positioned in various locations as is suitable for a particular use/application of the mobile secure network device 10. Data from the various sensors 70 are operatively connected to computing apparatus 12 in order to provide feedback from the surrounding environment thereto. The shape of the housing 16 and the mobile secure network device 10 is not limited to that illustrate and can resemble a cylinder, egg, disk, and virtually any suitable shape for a particular use/application including but not limited to a torso of a biped (human or other), quadruped, as well as many other shapes.

The various sensors 70 may be positioned on or within the various outside surfaces of the housing 16 of the mobile secure network device 10, as well as inside, to provide information regarding the exterior environment as well as operating conditions within the system 10. Further, a securely releasable sensor 72 such as a drone 74 may also be included and supported by the housing 16. The various sensors 70 can include cameras (visual, inferred, uv, or the like) which may be telescopic, 360-degree, wide angle, etc. The various sensors 70 can include ultrasonic, sonar, radar, Lidar (Light Detection and Ranging) as well as other types including temperature, humidity, gas, olfactory, electromagnetic, gravity, acceleration, etc. The various sensors 70 can include ground sensors, terrain sensors, gyroscopes, etc. as would be known to those of skill in the art. The sensors 70 may be specifically adapted for the particular use and/or environment, as would be known to those of skill in the art.

The sensor data that is gathered by the variety of sensors 70 and can be transferred to and utilized by a computer program that instructs the navigation of the independent mobility module, which may include, for example, servo motors, piston movement, etc. or other motors that may be used to propel the system 10 as well. The navigation may include a global navigation satellite system that may be integrated with additional complimentary technology including, but not limited to, ultrasonic, inertial motion, digital maps, or radar.

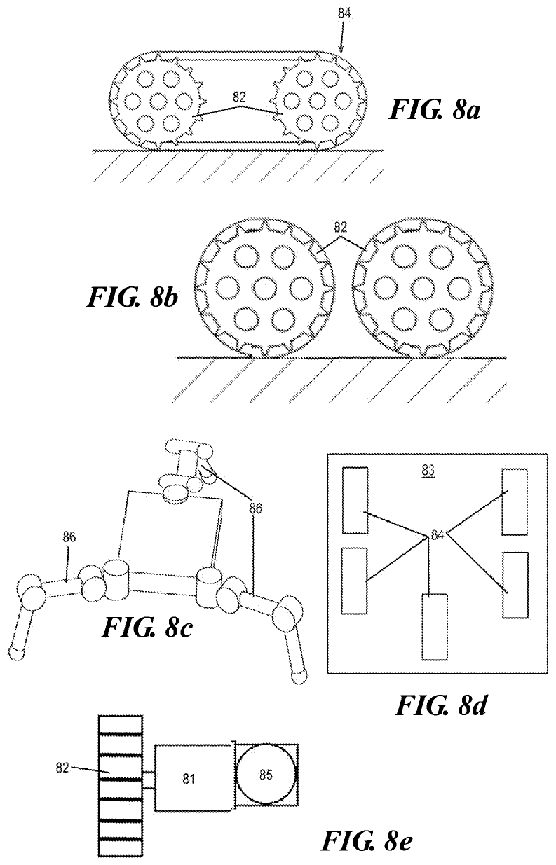

Housing 16 of the mobile secure network device 10 may include, be supported by, and connected to mobility mechanism 80 including a motor 81 and motion members, as described herein. Motor 81 may be a servo motor, hydraulic motor, piston movement, or other types of motors sufficient to provide power for movement. The mobility mechanism 80 can be fixed or interchangeable, allowing for a selection of the mobility mechanism 80 and motion members suitable for a particular use/application. The mobility mechanism may be formed as a unitary member with the housing 16 or may be a separate member including a separate frame or housing 83. The mobility mechanism 80 imparts motion to the mobile secure network device 10, allowing for the independent movement whose motion can be remotely controlled, for example through an encrypted link, a narrow beam link, as well as various other links that would be known to those skilled in the art. The motion can be semi-autonomous, autonomous, preprogrammed as well as a combination thereof and may include the use of artificial intelligence. Preprogrammed, autonomous and semi-autonomous motion control can request assistance before proceeding when an exception event is encountered by sensors 70 and relayed to the computing apparatus 12. Various styles of motion members are illustrated in FIGS. 8a-8e for use as part of the mobility mechanism 80.

FIG. 8a is an exemplary illustration of caterpillar tracks (tracks) 84 that may be used as a motion member for mobility mechanism 80. The caterpillar tracks 84 can be dual, single, as well as a plurality of treads to support and provide movement to the mobile secure network device 10. The caterpillar tracks 84 can be metal, soft material such as rubber, etc. and may include studs or other surface treatments for improved traction ability. The caterpillar tracks 84 can be side by side, inline as well as staggered in their location. The caterpillar tracks 84 may be dynamically positioned up and down (horizontally) as well as additionally vertically, enabling the mobile secure network 80 to remain stable and level on various terrain and slopes. This can be used to enable the independent mobility mechanism 80 to climb steps, traverse uneven terrain as well as objects. Operating the caterpillar tracks 84 at different speeds can enable directional control, steering, of the mobile secure network device 10.

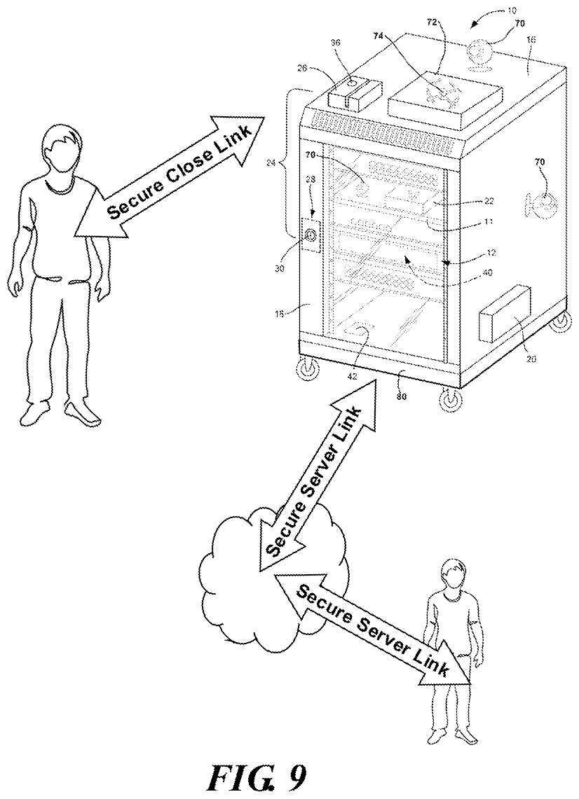

FIG. 8b is an exemplary illustration of wheels 82 that may be used as a motion member for mobility mechanism 80. The wheels 82 can be dual, single, as well as a plurality supported on the mobility mechanism 80 as shown in FIG. 9. They can be side by side, inline as well as staggered in their location. The wheels 82 may be dynamically positioned up and down (horizontally) as well as additionally vertically enabling the mobile secure network 80 to remain stable and level on various terrain and slopes. This can be used to enable the independent mobility mechanism 80 to climb steps, traverse uneven terrain as well as objects. Wheels 82 may be utilized with or without caterpillar tracks 84, or the like.

FIG. 8c is an exemplary illustration of appendages 86 that may be used as a motion member for mobility mechanism 80. The appendages 86 can be used to create a monopod, biped, tripod, quadruped, as well as other configurations. The appendages can form prismatic legs, articulated legs, and redundant articulated legs with various degrees of freedom. Sprawling type legs have large front and rear swings and can adjust the center of gravity to a low position. Their motion can enable the mobile secure network 10 to remain stable and level on various terrain and slopes. This can be used to enable the independent mobility mechanism 80 to climb steps, traverse uneven terrain as well as objects.

FIG. 8d is an exemplary embodiment illustrating inline and staggered positioning of the caterpillar tracks 84 from a bottom view of the mobility mechanism 80. These alignments as well as other alignments are also equally well suited for use with wheels or legs. By utilizing a combination of the alignments and dynamic positioning and height adjustment, such as for example through the use of pistons, the independent mobility mechanism 80 can climb steps and traverse rough terrain.

The caterpillar tracks 84 and wheels 82 described herein can be made of any suitable material, for example rubber, nylon, silica, polyester, carbon black, petroleum or metal or a combination thereof. They can be cogged as well as intermixed, providing a variety of types of traction capabilities for various terrains and weather conditions. Wheels 82, caterpillar tracks 84 and/or appendages 86 can be combined for greater flexibility.

FIG. 8e illustrates one type of drive mechanism. A drive motor 81 is shown attached to a wheel 82 (the wheel may be used to actuate a caterpillar track 84 or directly contact the surface). The drive motor 81 may be coupled to a pivot motor 85 to enable turning of the wheel 82 to steer the mobile secure network 10, as would be know to those of skill in the art.

FIG. 9 is a flowchart illustrating an embodiment of a mobile secure network device in accordance with FIG. 7 including sensors 70 and independent, self-propelled mobility. The close-range mode as well as the long-range mode has numerous applications including extensive remote inspection capabilities, utilizing the various sensors 70 including camera, telephoto camera, infrared and heat sensors, to name just a few. Such use can augment a variety of operations including, for example, the inspection of power lines both routinely and after a disaster such as a storm. The inspection can be augmented by use of the drone which is securely supported and linked to the system including a monitor to provide visualization of what is occurring to those users 90 operating the movement of the mobile secure network device 12. The ability to provide local communication links when cellular and other communication links fail or become over loaded can also be provided. The present device is also well suited for human interaction such as in search and rescue as well as for entertainment purposes etc.

The computer program that instructs the independent mobility module 80 can operate in various modes including remote control, tethered remote control, semi autonomous, fully autonomous as well as any suitable combination. Tethered remote as well as close-range untethered coupled remote control provide for a connected user to send instructions directly into the device, then cached and executed locally. Remote, or long-range, control instructions are sent through the secure network, then cached and executed locally. Autonomous control including semi-autonomous as well as fully autonomous movement can provide suitable movement based upon various sensor 70 data as well user instructions and are augmented with artificial intelligence.

Those skilled in the art will appreciate that the conception, upon which this disclosure is based, may readily be utilized as a basis for designing other products without departing from the spirit and scope of the invention as defined by the appended claims. Therefore, the claims are not to be limited to the specific examples depicted herein. For example, the features of one example disclosed above can be used with the features of another example. Furthermore, various modifications and rearrangements of the parts may be made without departing from the spirit and scope of the underlying inventive concept. Thus, the details of these components as set forth in the above-described examples, should not limit the scope of the claims.

Additionally, the purpose of the Abstract is to enable the U. S. Patent and Trademark Office, and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the claims of the application nor is intended to be limiting on the claims in any way.

What is claimed is:

1. A mobile secure network system comprising:
a computing apparatus configured to extend a remote home network to a current location of the network device so that one or more endpoint devices at the current location of the network device can join the remote home network;
a housing supporting the computing apparatus and constructed and arranged for mobile transport including a back-up power supply supported thereon;
an access control mechanism to allow access to the computing apparatus;
a mobility mechanism supporting the housing and including a motor and one or more motion members configured to impart motion to the mobile secure network device;
sensors positioned in various locations on an exterior of the housing configured to collect data from the surrounding environment; and
wherein the one or more sensors are communicatively connected to the computing apparatus supported within the housing in order to provide data regarding the surrounding terrain.

2. The system of claim 1, wherein the mobility mechanism includes one or more tract drives.

3. The system of claim 1, wherein the independent mobility mechanism includes one or more wheels.

4. The system of claim 1, wherein the independent mobility mechanism includes one or more articulated legs.

5. The system of claim 1, wherein the mobility mechanism is semi-autonomously controlled.

6. The system of claim 1, wherein the independent mobility mechanism is autonomously controlled.

7. The system of claim 5, wherein sensor data provides input for the semi autonomously controlled system.

8. The system of claim 1, further comprising a security control module communicationally connected to the access control mechanism and configured to deny access to the housing upon occurrence of one or more predefined occurrences selected from a group including unverified users attempting to gain access to the computing apparatus through the access control mechanism, failure to synchronize a local cache with a remote cache on a parent network, a physical breach of the housing, and power loss.

9. The system of claim 1, wherein a request for assistance is sent to the home network before proceeding when an exception event is encountered by the sensors and relayed to the computing apparatus

10. A mobile secure network device comprising:
a computing apparatus configured to extend a remote home network to a current location of the network device so that one or more endpoint devices at the current location of the network device can join the remote home network;
a local cache of data stored by the computing apparatus;
a housing supporting the computing apparatus and constructed and arranged to be independently driven by a mobility mechanism including a motor and one or more motion members configured to impart motion to the mobile secure network device when receiving commands from the computing apparatus;
a back-up power supply supported by the housing; and
wherein data from the various sensors are received by the computing apparatus supported within the housing in order to negotiate changing conditions in terrain.

11. The device of claim 10, wherein to secure the data on the local cache the data is deleted from the local cache and access to the remote home network is disabled.

12. The device of claim 10, wherein the independent mobility mechanism includes one or more tract drives.

13. The device of claim 10, wherein the independent mobility mechanism includes at least one driven wheel.

14. The device of claim 10, wherein the independent mobility mechanism includes at least one articulated leg.

15. The device of claim 10, wherein the independent mobility mechanism is remotely controlled.

16. The device of claim 10, wherein the independent mobility mechanism is semi-autonomously controlled.

17. The device of claim 10, wherein the independent mobility mechanism is autonomously controlled.

18. The device of claim 15, wherein the remotely controlled system uses an encrypted link.

19. The device of claim 10, wherein prior to deleting the data from the local cache it is transferred to the home network.

20. The device of claim 10, wherein when an exception event is encountered by sensor data, the mobile secure network system requests instructions from the home network before proceeding.

21. The device of claim 10, wherein the independent mobility mechanism is preprogrammed and requests additional instructions when an exception event is encountered.
